(19) United States
(12) Patent Application Publication
(10) Pub. No.: US 2005/0010543 A1
(43) Pub. Date: Jan. 13, 2005

(54) Scoring methodology

(76) Inventors: Jon Lukomnik, New York, NY (US); Stephen M. Davis, Newton, MA (US); Howard D. Sherman, New York, NY (US)

Correspondence Address: KATTEN MUCHIN ZAVIS ROSENMAN, 575 MADISON AVENUE, NEW YORK, NY, 10022-2585, US

(21) Appl. No.: 10/496,952

(22) PCT Filed: Nov. 20, 2002
(86) PCT No.: PCT/US02/37269

Related U.S. Application Data
(60) Provisional application No. 60/337,712, filed on Dec. 5, 2001.

(51) Int. Cl. G06F 17/00; G06N 5/02

(52) U.S. Cl. 706/46

(57) ABSTRACT

A scoring methodology combines asymmetric and non-linear arithmetic scoring base on relative scores across a universe of entities. The methodology provides a research template (100) that can be utilized to forecast corporate governance risk ratings of companies and markets. The research template (100) is made up data points such as: indicators (120, 122, 124, 126), normative statements (108, 110, 112, 114, 116, 118), or categories (102, 104, 106). Indicator scores build to yield a normative statement score; normative statement scores build to yield a category score; and category scores build to yield an overall heading score.

The present application claims the benefit of U.S. provisional patent application “Scoring Methodology”, application Ser. No. 60/337,712, filed Dec. 5, 2001.

### TECHNICAL FIELD

The present invention relates generally to the field of statistical analysis. More specifically, the present invention is related to computer-based surveys, scoring and rating techniques.

### BACKGROUND ART

The following references illustrate a general cross-section of known U.S. patents performing computer-based surveys.

The U.S. patent to Graham et al. (U.S. Pat. No. 5,893,098) provides a system for obtaining information from a plurality of computer users, comprising: (a) a processing apparatus including an input mechanism through which a survey author may input data; (b) a survey authoring mechanism enabling construction of a survey questionnaire document including at least one question formulated from data input by the survey author; (c) a transmission mechanism for transmitting the survey questionnaire document to a plurality of respondent users; and (d) a processing apparatus, including a collating mechanism arranged to receive transmissions from the transmission mechanism, to identify response documents which include responses to at least one question from the plurality of respondent users and to load a database in accordance with the responses.

The U.S. patent to Ito et al. (U.S. Pat. No. 5,725,384) provides for a system wherein a questionnaire agency company stores individual information of a number of answerers in a database in a questionnaire agency system. When a client enters desired conditions, information pertaining to answerers who meet the conditions is retrieved automatically. The number of the answerers is presented to the client. Upon client approval, the contents of a questionnaire are sent to the chosen answerers by telephone or facsimile, and replies to the questionnaire are collected.

The U.S. patent to Fuerst (U.S. Pat. No. 6,189,029) provides for a software tool that permits creation of electronic surveys and the automatic collection and tabulation of survey results corresponding to user responses. Using the tool, a survey is automatically created and posted at a website address. With a web client, or browser, computer users access the URL and complete the survey via the web. Survey results are collected in a relational database as each user completes the survey. Thereafter, statistical tools or other analytical software applications may be applied to data mine the tabulated results. In another preferred embodiment, the software tool is utilized to access remote servers running relational databases from an Internet computer via the web. Advantageously, the computer does not require the computational processor power or memory (i.e., system memory or disk storage capacity) normally required to load and operate the applicable relational database application software.

The U.S. patent to Walker et al. (U.S. Pat. No. 6,093,026) provides for a controller such as an online service provider computer or an ISP computer which receives a survey including questions from a client desiring to have a survey conducted. The controller creates respondent questions based on the survey questions. The controller also selects one or more respondents from a list of possible respondents, such as a list of customer accounts. The respondent questions are transmitted to the selected respondents. Responses corresponding to the respondent questions are received. The controller applies an inconsistency test to the responses to generate an inconsistency test result. The inconsistency test determines if the responses originate from computers or humans not paying attention to the questions. Based on the inconsistency test result, a fraud signal may be generated. The fraud signal may result in several actions, such as the controller ignoring the responses received from the corresponding respondent, reducing or eliminating payment to the respondent, transmitting a message of reprimand to the respondent, and/or barring the respondent from future participation in surveys.

The U.S. patent to Barney et al. (U.S. Pat. No. 6,070,143) provides for a method for use with a computer, including a job analysis system and a method of operating a computer to allow it to perform job analysis. In one embodiment, the job analysis system includes: a master job analysis database containing work-oriented, worker-oriented and work context dimensions and work-oriented, worker-oriented and work context dimension job analysis survey portions associated therewith; a products database containing human resource products; and a knowledge management module associated with the master job analysis database. The knowledge management module includes: a survey assembly program that allows a user to select ones of the work-oriented, worker-oriented and work context dimensions from the master job analysis database and create a job analysis survey from the associated ones of the job analysis survey portions; and a survey analysis program that allows the user to identify key worker-oriented dimensions and link the key worker-oriented dimensions to the human resource products in the product database.

The U.S. Pat. No. 4,958,284 provides for a method and system for data processing open-ended respondent answers to open-ended questions, providing reproducible categorized dynamically variable coding of the open-ended respondent answers to the open-ended questions. The data processor has an updateable retrievable word dictionary for words stored therein, with the open-ended answers comprising words. The open-ended answers are input to the data processor and classified into corresponding word types such as keywords, modifiers, skip words, connectors, and negative words, with combined keywords and associated modifiers forming key phrases. The input words are converted into corresponding binary-coded words for providing a binary-defined sentence corresponding to the open-ended input respondent answer. The binary defined sentence is scanned, and any keywords and associated modifiers are extracted to create a retrievable file comprising key phrases formed from the extracted keywords and associated modifiers and the keywords per se. Key phrases are sorted in the created file, and occurrences of sorted key phrases are counted with duplicates eliminated in order to provide a net key phrase file. The net key phrase file is displayed to the operator, who then groups the displayed net key phrases into a coding structure which is stored and can be updated or modified under the control of the operator.

Whatever the precise merits, features and advantages of the above-cited references, none of them achieves or fulfills the benefits of the present invention.

### DICSLOSURE OF INVENTION

The present invention provides for a scoring methodology that combines asymmetric and non-linear arithmetic scoring based on relative scores across a universe of entities. In the exemplary embodiment, the methodology is implemented using a research template comprising a plurality of data points. In the preferred embodiment, the data points are any of the following: indicators, normative statements, or categories. Indicator scores build to yield a normative statement score; normative statement scores build to yield a category score; and category scores build to yield an overall heading score. In a specific implementation, the methodology of the present invention is used to implement a corporate governance risk scoring system.

In one embodiment, the present invention's research template is a “decision tree” formatted research template combining indicative statements, normative statements, and categories. In another embodiment, the decision tree formatted research template is provided with subjective input to a single “leaf” to enable expertise to be captured in the scoring algorithm.

Thus, the methodology of the scoring system of the present invention provides for the ability to segregate scores within normative statements or other categories and score these categories on an arithmetic basis (wherein a broader category score is calculated based upon combining the scores of these categories on an asymmetric and/or non-arithmetic basis).

In an exemplary embodiment, scores are biased using a forced distribution or a “GMI Curve”. The GMI curve is a skewed normal distribution curve wherein the mean μ associated with a normal distribution curve is skewed to allow for a curve with a mean higher than μ. Thus, the GMI curve translates normative statistics into intuitive risk weightings.

### BRIEF DESCRIPTION OF THE DRAWINGS

FIG. 1 illustrates an example showing the organizational view of the present invention's research template.

FIGS. 2a-e collectively illustrate examples of sample research templates implemented according the present invention's methodology.

FIGS. 3a and 3b collectively illustrate the scoring methodology associated with the exemplary embodiment of the present invention.

FIG. 4 illustrates a table associated with the GMI curve which takes a normal distribution curve and skews it to allow a slightly higher mean (6.5 versus 5.0) and to control the number of rated entities that can be included in the tails of the distribution.

FIG. 5 illustrates a plot of the table in FIG. 4.

FIG. 6 illustrates the method associated with AGS.

### MODES FOR CARRYING OUT THE INVENTION

While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered an exemplification of the principles of the invention and the associated functional specifications for its construction and is not intended to limit the invention to the embodiment illustrated. Those skilled in the art will envision many other possible variations within the scope of the present invention.

It should be noted that throughout the figures and specification, specific examples of “indicators statements”, “normative statements”, categories, and headings are used to describe the scoring methodology of the present invention. However, other examples are envisioned, and the disclosed examples should not be used to limit the scope of the present invention.

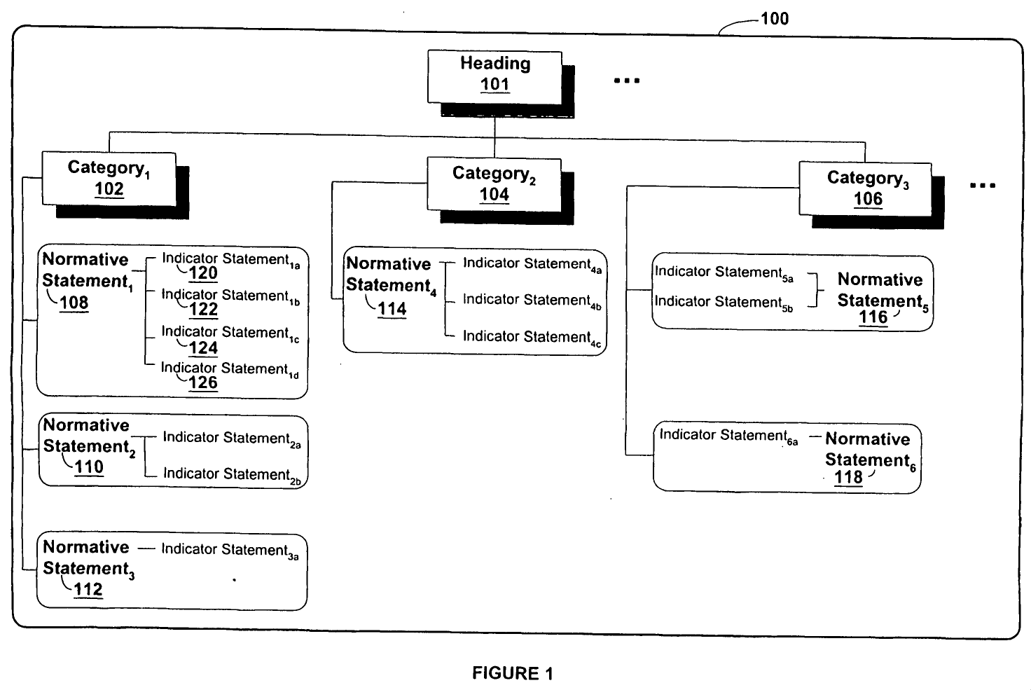

The present invention provides for a scoring methodology that combines asymmetric and non-linear arithmetic scoring based on relative scores across a universe of entities. In the exemplary embodiment, the methodology is implemented using a research template comprising a plurality of data points. FIG. 1 illustrates an example showing the organizational view of the present invention's research template 100. The detailed research template is based on a plurality of individual data points. The data points are any of the following: “categories” (102, 104, and 106), “normative statements” (108, 110, 112, 114, 116, and 118), or “indicators” (e.g., indicators 120, 122, 124, and 126 under normative statement 108).

Scores associated with “Indicators” (or “indicative statements”) 120, 122, 124, and 126 under normative statement 108 build to yield a normative statement score. Similarly, scores associated with normative statements 108, 110, and 112 build to yield category scores associated with category 102. Lastly, category scores associated with categories 102, 104, and 106 build to yield an overall “headline rating” associated with heading 101.

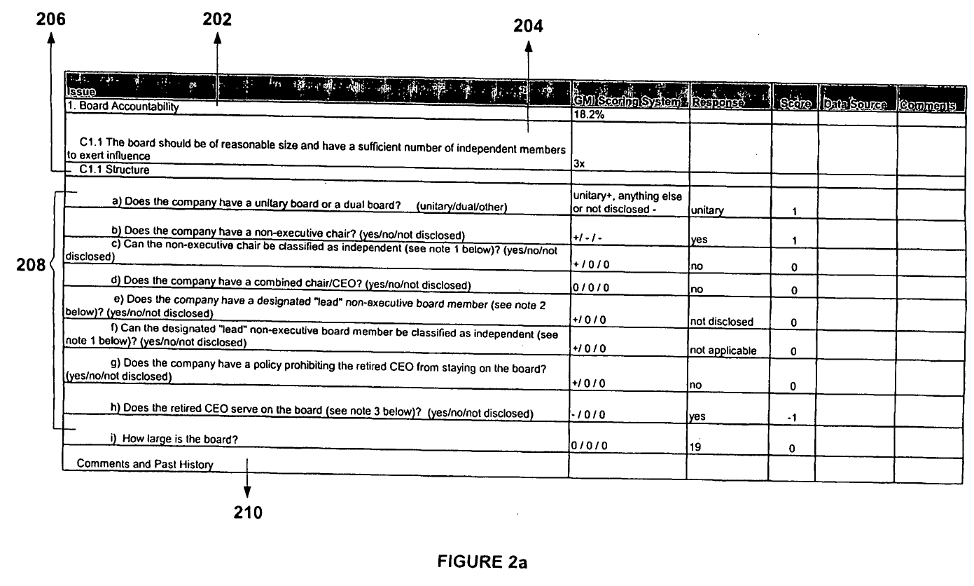

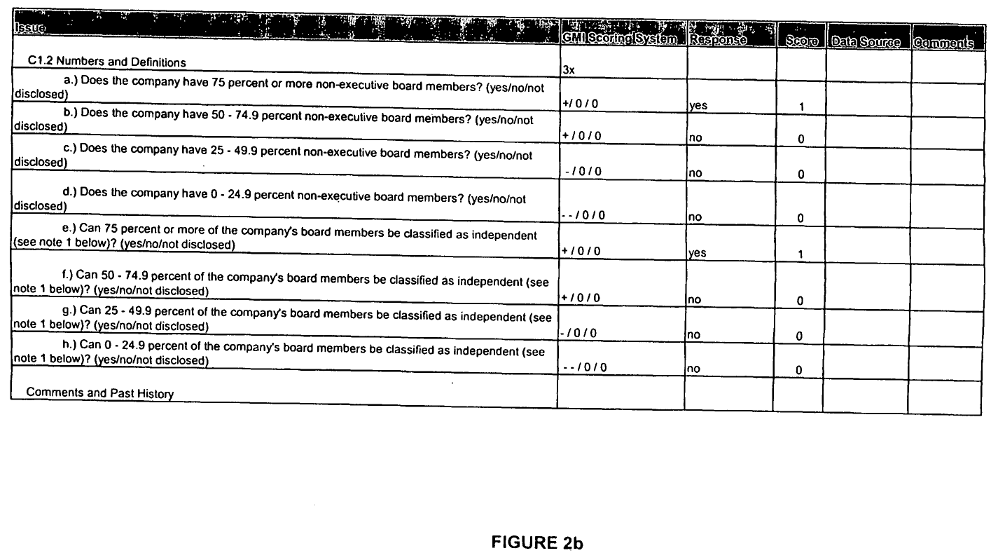

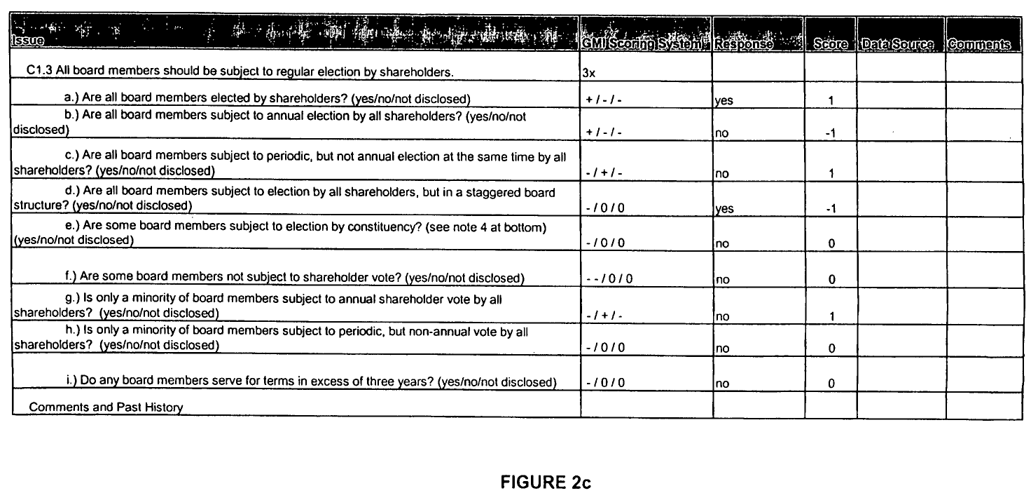

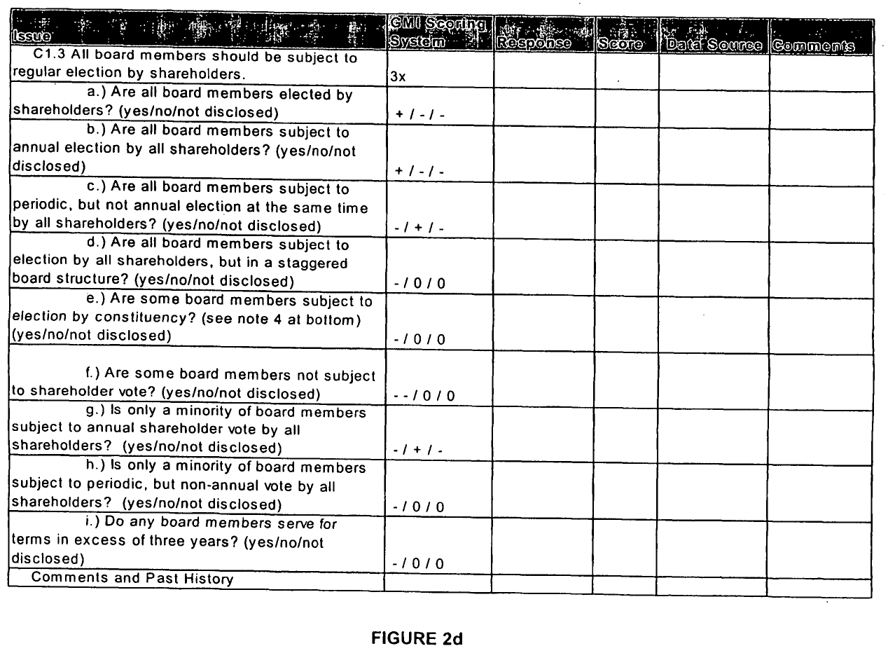

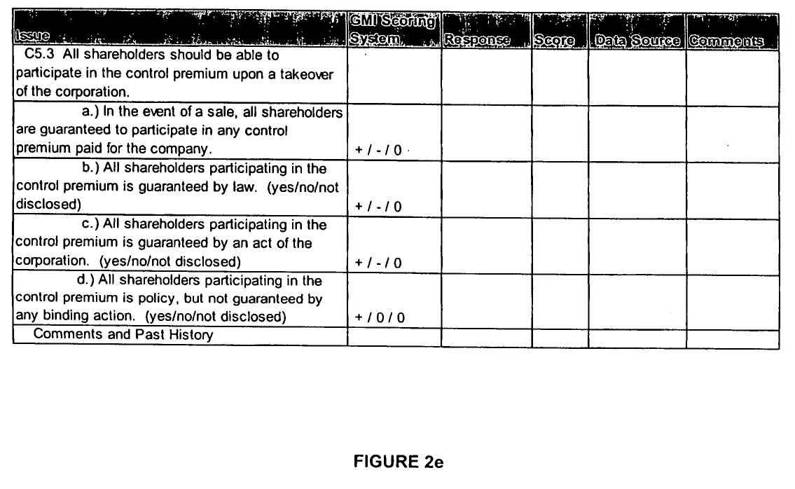

FIGS. 2a-e collectively illustrate examples of sample research templates implemented according the present invention's methodology. Rows 202 of FIG. 2a entitled “1. Board Accountability” represents the category data point. Rows 204 and 206 of FIG. 2a entitled “C1.1 The board should be of reasonable size and have a sufficient number of independent members to exert influence” and “C1.1 Structure” correspond to the normative statement data point. All normative statements have assigned and scaleable weights, such as 1×, 2× or 3×; or 10 points or 25 points. The rows indicated by 208 correspond to indicator statements under the normative statements provided in rows 204 and 206. Indicators statements are questions that can be answered objectively and specifically, such as “Does the company have an audit committee?” FIGS. 2b and 2c illustrate a similar example of indicator statements and normative statements under the “Board Accountability” category 202 of FIG. 2a. FIGS. 2d and 2e illustrate additional examples of indicator statements (e.g., “C 1.3 All board members should be subject to regular elections by shareholders” of FIG. 2d and “C 5.3 All shareholders should be able to participate in the control premium upon a takeover of the corporation” of FIG. 2e).

In one embodiment, a decision tree formatted research template is provided with subjective input to a single “leaf” to enable expertise to be captured in the scoring algorithm. The decision tree captures all the dimensions of a “fact” that are considered probable. For example, a simple normative statement (e.g., “The company should safeguard shareholder voting rights by facilitating ballot access”) is provided with twenty indicator statements under this normative statement. These indicator statements capture various options such as, but not limited to: the ways people can vote (in person, in person proxy, mail, telephone, internet, etc.), what documentation is required, record dates, share blocking, and even where the annual general meetings are held. But, if a company tried to keep people from voting the year before by deciding to hold a meeting at 5 pm on Christmas Eve, only to be overturned by a court—an analyst notices that, and believes it does not “safeguard shareholder voting rights.” But, clearly, that confluence of events would never be a question on any decision tree (Did the company, in the midst of a shareholder battle, attempt to hold a vote at 5 pm on Christmas Eve, but was turned down by the court, so the vote never happened?). Yet, the analyst has good, but subjective reasons to believe the company does not “safeguard shareholder voting rights”. The template of the present invention accounts for such situations by providing a “leaf” on the decision tree which is blank, or says “Comments and Past history” 210. This provides a single leaf to which the analyst can put in such situations, along with a recommended scoring adjustment. The advantage to this is that quality control can check the leaf, both for factual accuracy, and for cross-analyst patterns (i.e., one analyst makes too many adjustments, others never make any) so as to normalize the human variable in scoring.

The limited range of answers associated with each indicator statement or question enables each answer to be assigned a score. It should be noted that in the exemplary embodiment, indicators are designed to be able to be answered in a modified binary way: “yes”, “no”, or “not disclosed”. The indicator answers are scored against a template. For example, “yes” may equal +1, “no” may equal −1, and “not disclosed” may equal 0. Alternatively, weightings may be assigned, or some indicator answers may be scored and others not, i.e., “yes” equals −1, “no” is not scored, and “not disclosed” is not scored. It should be noted that the questions and weightings disclosed are mere examples, and other questions and weighting can be interchanged without departing from the scope and content of the present invention. All indicator statement scores, under any normative statement score, are added to yield a “raw” score for that normative statement. Each entity's raw score for that normative statement is compared to the universe of entities' raw scores for that same normative statement.

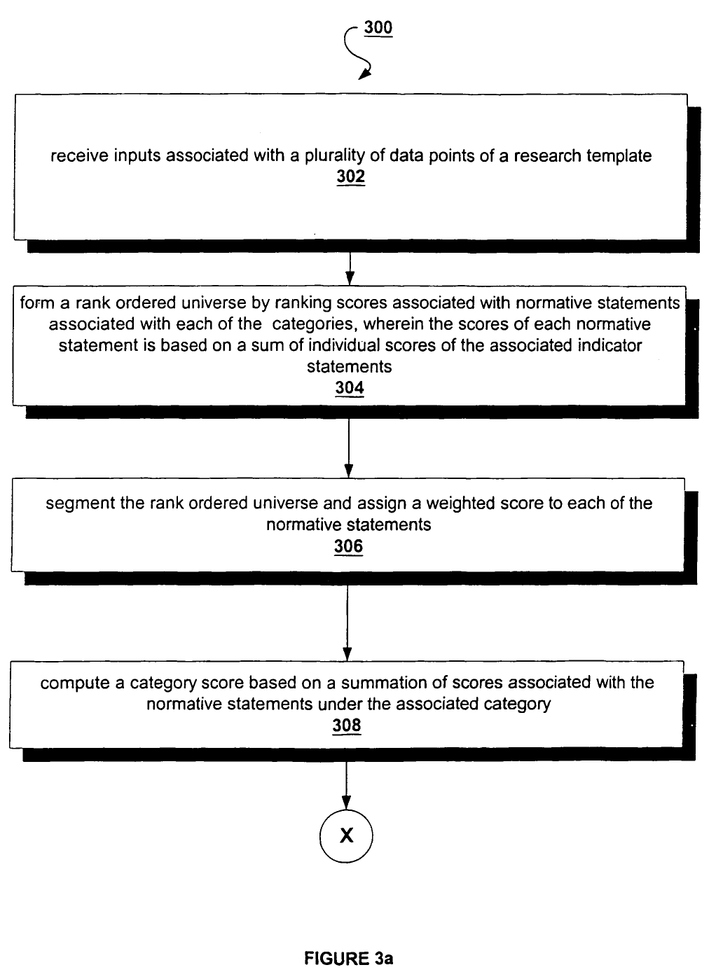

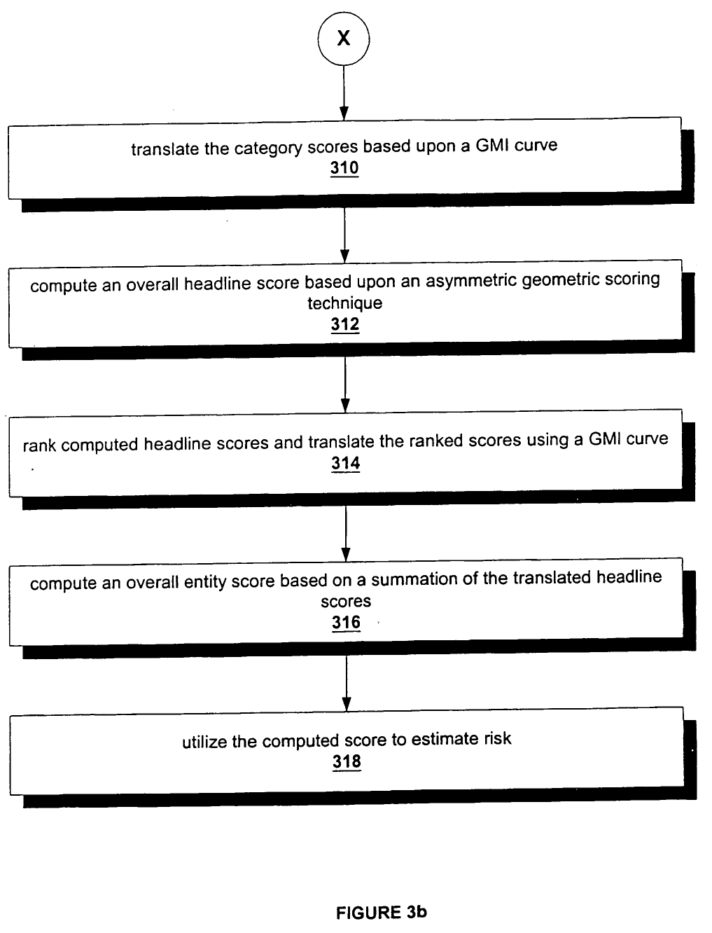

FIGS. 3a and 3b collectively illustrate the scoring methodology 300 associated with the exemplary embodiment of the present invention. Method 300 comprises the following steps:
Step 302: Inputs associated with a plurality of data points of a research template are received.
Step 304: A rank ordered universe is formed by ranking scores associated with normative statements associated with each of the categories wherein the scores of each normative statement is based on a sum of individual scores of the associated indicator statements.
Step 306: The rank ordered universe is segmented, and a weighted score is assigned to each of the normative statements.
Step 308: A category score is computed based on a summation of scores associated with the normative statements under the associated category.
Step 310: The category scores are translated based upon a GMI curve.
Step 312: An overall headline score is computed based upon an asymmetric geometric scoring (AGS) technique.
Step 314: Computed headline scores are ranked, and the ranked scores are translated using a GMI curve.
Step 316: An overall entity score is computed based on a summation of the translated headline scores.
Step 318: Lastly, the computed score is utilized in estimating risk ratings of companies and markets.

It should be noted that entities are ranked by the raw score total of all indicator statements included under the normative statement. The rank-ordered universe is then divided into segments; and all, part, none, partial negative, or total negative scaleable weight of the normative statement is assigned. For example, in a situation where the normative statement is worth 10 points and the rank order divided into quintiles, the top quintile would receive +10 points, the second quintile +5 points, the middle quintile 0 points, the fourth quintile −5 points, and the fifth quintile −10 points. Should the rank order be divided in thirds, the top third in this example would receive 10 points (the weighted score for that normative statement), the middle third would receive 0 points, and the bottom third would receive −10 points (negative the normative statement weight).

In cases in which there is a grouping of observations that straddles a “break point” (e.g., a number of entities have the same raw scores and constitute a group below, at, and above a quintile or other division point), those entities should be given the mean score to which they would otherwise be entitled. For example, in the case above where 0 points were to be assigned to the top quintile and 5 points to the second quintile, the group that straddled the division point would receive 7.5 points. To arrive at a category score, the normative statement scores are added in a straight arithmetic fashion to get a raw category score.

In the exemplary embodiment, the raw category scores are converted to final category scores by forcing the distribution of scores into a distribution based on the “GMI Curve,” a proprietary 10-point distribution. The purpose of the GMI curve is to translate normative statistics into more intuitive risk weightings.

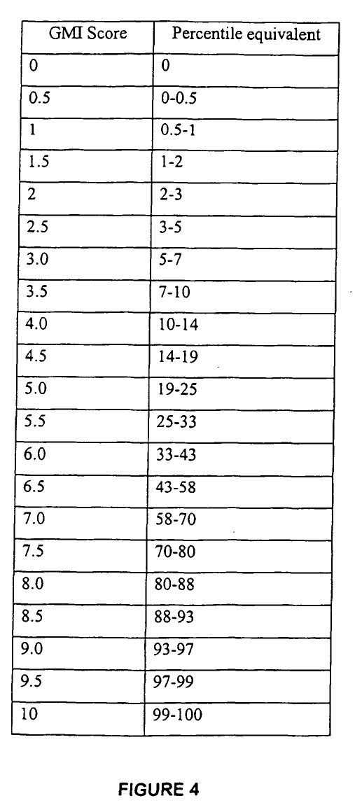

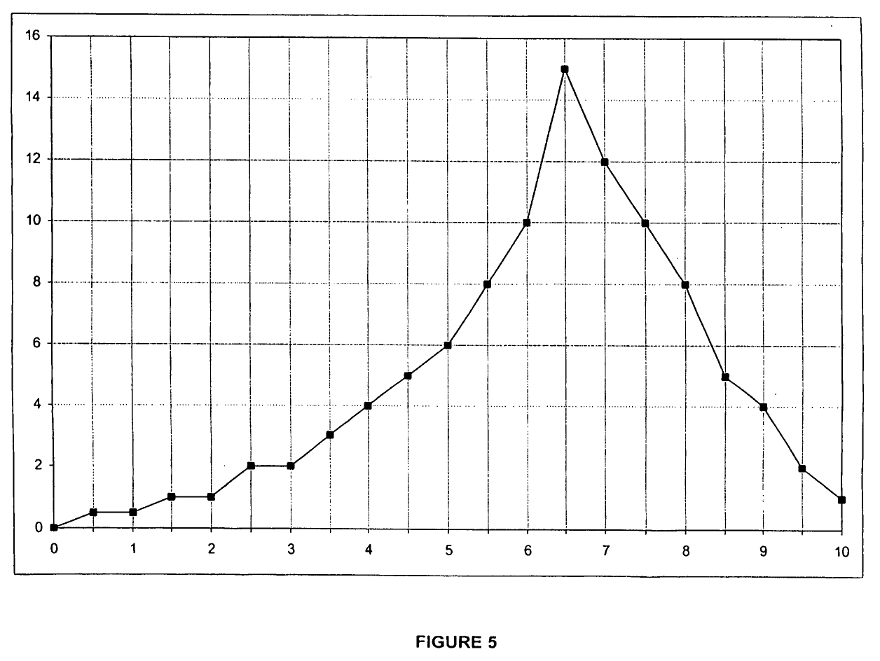

FIG. 4 illustrates a table associated with the GMI curve which takes a normal distribution curve and skews it to allow a slightly higher mean (6.5 versus 5.0) and to control the number of rated entities that can be included in the tails of the distribution. This ensures that the tail observations are true outliers. To give some sense of proportion, if 1,000 entities are ranked, only 50 will receive scores of 2.5 or below and only 70 will receive scores of 9.0 or better, but 610 will receive ratings of from 5.0-7.5. FIG. 5 illustrates a plot of the table in FIG. 4, wherein the x-axis represents the GMI score and the y-axis is the difference in the percentage equivalent range for a particular GMI score. The purpose of the GMI curve is to translate normative statistics into more intuitive risk weightings, grouping the largest number of observations around a point slightly above the mean, and emphasizing the few observations which are truly outliers.

Category scores (as adjusted for the GMI curve) build to create the overall entity, or “headline” score. (See the discussion of asymmetric geometric scoring following to understand how category scores build up to the overall entity rating). Each category score has a weighting towards the overall, or “headline” score.

Asymmetric geometric scoring (AGS) is used to arrive at the overall, or “headline” rating. (AGS is based on the findings of behavioral finance research, which has shown, among other things, that investors are sensitive to events that are outliers in any distribution, and that investors have asymmetric reactions to those outliers depending on whether they are positive or negative outliers. Otherwise stated, the utility function of the investor is not the same for positive and negative outcomes and is non-linearly sensitive to observations at the extremes of the distribution).

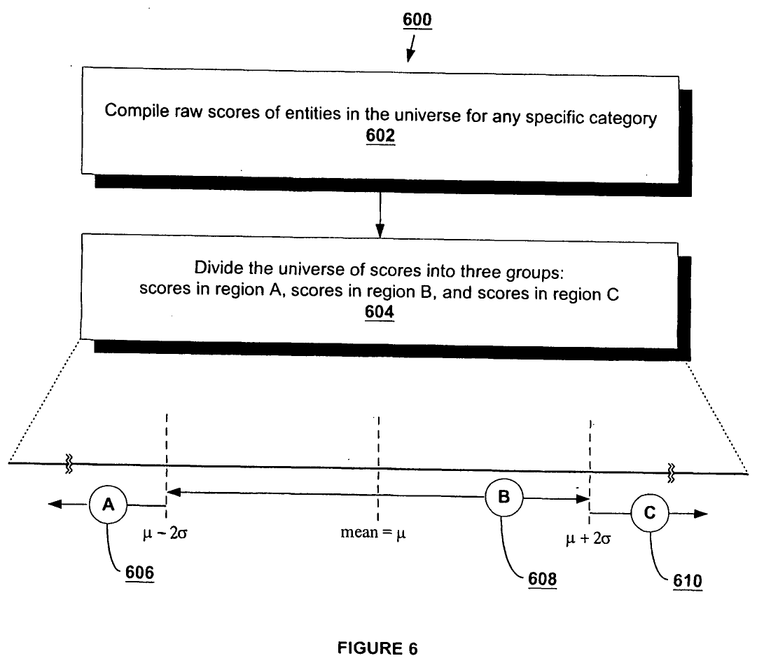

FIG. 6 illustrates the method 600 associated with AGS. In step 602, all raw scores associated with all entities in the universe are compiled for every category score. In step 604, the universe of scores is divided into three groups: scores that fall in region A 606, scores that fall in region B 608, and scores that fall in region C 610. Scores in region A 606 represent scores that are two or more standard deviations below the mean μ (i.e., region A represents scores that are below μ−2σ, where σ is the standard deviation of the scores). Scores in region B 608 represent scores that are between two standard deviations below the mean and two standard deviations above the mean (i.e., region B represents scores that are between μ−2σ and μ+2σ). Scores in region C 610 represent scores that are two or more standard deviations above the mean (i.e., region C represents scores that are above μ+2σ).

For those entities that score between two standard deviations below the mean and two standard deviations above the mean, the entity's final category score (based on the GMI curve) is multiplied by the category weighting. The product is the contribution of the category score towards the overall entity rating. This is called the normal arithmetic contribution (NAC).

For those entities that score two standard deviations or more below the mean, the normal arithmetic contribution is the starting point of computing the contribution of a category score to the overall entity, or “headline”, rating. Two times the difference between the normal arithmetic contribution and the maximum possible category score is then subtracted from the normal contribution. The sum is the total contribution of that category towards the overall entity rating. In other words, if an entity's raw score is two or more standard deviations below the mean in any category, the total contribution of that category towards the “headline” score would be normal arithmetic contribution −2* (NAC−maximum category score).

For those entities that score two standard deviations or more above the mean, the contribution of that category score towards the overall or “headline” score is 1.5 times the normal arithmetic contribution (1.5*NAC). A variant of asymmetric geometric scoring is to increase the penalties/rewards as the observation falls further away from the mean. For example, a two standard deviation positive observation may receive 1.5*NAC while a 2.1 standard deviation positive observation may receive 1.6*NAC, a 2.2 standard deviation positive observation may receive 1.7*NAC, etc. It should, however, be noted that the above example is for illustrative purposes only and the increased penalties/rewards need not progress in an arithmetic manner.

The raw “headline”, or overall entity rating, is the sum of all the category contributions to the “headline” or overall rating. The raw “headline” scores are then converted to a final overall entity score by ranking the universe of entities being scored and then converting those scores using the GMI curve.

Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code-based products are software modules for: (a) assisting in receiving inputs associated with a plurality of data points of a research template; (b) forming a rank ordered universe by ranking scores associated with normative statements associated with each of the categories, wherein the scores of each normative statement is based on a sum of individual scores of the associated indicator statements; (c) segmenting the rank ordered universe and assigning a weighted score to each of the normative statements; (d) computing a category score based on a summation of scores associated with the normative statements under the associated category; (e) translating the category scores based upon a GMI curve; (f) computing an overall headline score based upon an asymmetric geometric scoring (AGS) technique; (g) ranking computed headline scores and translating the ranked scores using a GMI curve; (h) computing an overall entity score based on a summation of the translated headline scores; and (i) estimating risk ratings of companies and markets based on the computed score.

A system and method has been shown in the above embodiments for the effective implementation of a scoring methodology. While various preferred embodiments have been shown and described, it will be understood that there is no intent to limit the invention by such disclosure but, rather, it is intended to cover all modifications and alternate constructions falling within the spirit and scope of the invention, as defined in the appended claims. For example, the present invention should not be limited by type of indicator statements, type of categories, type of headings, specific weighting scheme, specific score values, specific weighting values, software/program used to implement modules of the present invention's scoring methodology, or computing environment.

The above enhancements are implemented in various computing environments. For example, the modules of the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT), and/or hardcopy (i.e., printed) formats. The programming of the present invention may be implemented by one of skill in the art in statistical analysis programming.

1. A decision tree formatted research template (100) for estimating a risk score, said template (100) comprising:
a. one or more normative statements (108, 110, 112, 114, 116, 118);
b. one or more indicator statements (120, 122, 124, 126) associated with each of said normative statements, whereby a response to each of said indicator statements defines an indicator statement score, and a summation of indicator statement scores under each normative statement provides a normative score associated with each of said normative statements,
c. one or more headings (101);
d. one or more categories (102, 104, 106) associated with each of said headings, whereby a category score is computed by weighting and summing said normative scores under each of said headings, and a heading score is computed via biasing said category scores via a GMI score and an asymmetric geometric scoring technique; and
whereby an estimated risk score is computed based upon biasing said heading scores based upon a GMI curve:

2. A decision tree formatted research template (100) for estimating a risk score, as per claim 1, wherein said asymmetric geometric scoring technique comprises the steps of:
a. dividing category scores into the following regions: scores in a first region representing category scores that are two or more standard deviations below the mean, scores in a second region representing category scores that are between two standard deviations below the mean and two standard deviations above the mean, and scores in a third region representing scores that are two or more standard deviations above the mean;
b. for a category score that fall in said first region, the total contribution of that category towards said headline score is given by: normal arithmetic contribution −2*(NAC−maximum category score);
c. for a category score that fall in said second region, the total contribution of that category towards said headline score is given by the product of the category score and the category weighting; and
d. for a category score that falls in said third region, the contribution of that category score towards said headline score is 1.5 times the normal arithmetic contribution.

3. A decision tree formatted research template (100) for estimating a risk score, as per claim 1, wherein said template further comprises a leaf (210) under each of said normative statements, said leaf allowing for additional entries not covered by said indicator statements, said leaf providing for an adjustment in associated normative statement scores.

4. A decision tree formatted research template (100) for estimating a risk score, as per claim 1, wherein said indicator scores are a modified binary score, said modified binary score having any of the following values: −1, 0, or +1.

5. A decision tree formatted research template (100) for estimating a risk score, as per claim 1, wherein said risk score is a corporate governance risk rating.

6. A scoring method to calculate risk, said scoring method comprising the steps of:
a. rendering a research template (100), said research template comprising one or more headings (101), one or more categories (102, 104, 106) associated with each of said headings, one or more normative statements (108, 110, 112, 114, 116, 118) associated with each of said categories, and one or more indicator statements (120, 122, 124, 126) associated with each of said normative statements;
b. sequentially computing normative statement scores, indicator statement scores, category scores, and heading scores based upon said received inputs, said normative statement scores computed based upon a summation of associated indicator statement scores, said category scores computed based upon a summation of GMI curve translated normative statement scores, said heading scores computed based upon an asymmetrical geometric scoring of said category scores;
c. calculating an overall risk score based upon a summation of GMI translated heading scores; and
d. rendering said calculated risk score.

7. A scoring method to calculate risk, as per claim 6, wherein said asymmetrical geometric scoring is based upon:
a. dividing category scores into the following regions: scores in a first region representing category scores that are two or more standard deviations below the mean, scores in a second region representing category scores that are between two standard deviations below the mean and two standard deviations above the mean, and scores in a third region representing scores that are two or more standard deviations above the mean;
b. for a category score that fall in said first region, the total contribution of that category towards said headline score is given by: normal arithmetic contribution −2*(NAC−maximum category score);
c. for a category score that fall in said second region, the total contribution of that category towards said headline score is given by the product of the category score and the category weighting; and
d. for a category score that falls in said third region, the contribution of that category score towards said headline score is 1.5 times the normal arithmetic contribution.

8. A scoring method to calculate risk, as per claim 6, wherein said indicator scores are a modified binary score, said modified binary score having any of the following values: −1, 0 or +1.

9. A scoring method to calculate risk, as per claim 6, wherein said computed risk score is a corporate governance risk rating.

10. A scoring methodology that combines asymmetric and non-linear arithmetic scoring to predict corporate governance risk, said method comprising the steps of:
a. receiving inputs associated with one or more headings (101), one or more categories (102, 104, 106) associated with each of said headings, one or more normative statements (108, 110, 112, 114, 116, 118) associated with each of said categories, and one or more indicator statements (120, 122, 124, 126) associated with each of said normative statements;
b. computing a normative score associated with each normative statements based upon a summation of indicator scores of associated indicator statements, and values of said indicator scores extracted from received inputs;
c. computing a category score associated with each categories based upon a summation of said computed normative scores, and values of said normative scores extracted from received inputs;
d. translating said calculated category scores based upon a GMI curve;
e. computing an overall headline score based upon an asymmetric geometric scoring of weighted translated category scores;
f. computing an overall entity score based upon a summation of translated computed headline scores, said translation done via said GMI curve; and
g. utilizing said overall entity score to predict said corporate governance risk.

11. A scoring methodology that combines asymmetric and non-linear arithmetic scoring to predict corporate governance risk, as per claim 10, wherein said asymmetric geometric scoring is based upon:
a. dividing category scores into the following regions: scores in a first region representing category scores that are two or more standard deviations below the mean, scores in a second region representing category scores that are between two standard deviations below the mean and two standard deviations above the mean, and scores in a third region representing scores that are two or more standard deviations above the mean;
b. for a category score that fall in said first region, the total contribution of that category towards said headline score is given by: normal arithmetic contribution −2*(NAC−maximum category score);
c. for a category score that fall in said second region, the total contribution of that category towards said headline score is given by the product of the category score and the category weighting; and
d. for a category score that falls in said third region, the contribution of that category score towards said headline score is 1.5 times the normal arithmetic contribution.

12. A scoring methodology that combines asymmetric and non-linear arithmetic scoring to predict corporate governance risk, as per claim 10, wherein said indicator scores are a modified binary score, said modified binary score having any of the following values: −1, 0, or +1.

13. A scoring methodology that combines asymmetric and non-linear arithmetic scoring to predict corporate governance risk, as per claim 10, wherein said normative statement scores are adjusted based on received inputs in a leaf (210) under at least one of said normative statements, said leaf allowing for additional entries not covered by said indicator statements.

14. A scoring methodology that combines asymmetric and non-linear arithmetic scoring to predict corporate governance risk, as per claim 10, wherein said method is implemented across networks.

15. A scoring methodology that combines asymmetric and non-linear arithmetic scoring to predict corporate governance risk, as per claim 14, wherein said networks comprises any of the following: local area networks (LANs), wide area networks (WANs), or the Internet.

16. An article of manufacture comprising a computer usable medium implementing a scoring methodology that combines asymmetric and non-linear arithmetic scoring to predict corporate governance risk, said medium comprising:
a. computer readable program code aiding in receiving inputs associated with one or more headings, one or more categories associated with each of said headings, one or more normative statements associated with each of said categories, and one or more indicator statements associated with each of said normative statements;
b. computer readable program code computing a normative score associated with each normative statements based upon a summation of indicator scores of associated indicator statements, and values of said indicator scores extracted from received inputs;
c. computer readable program code computing a category score associated with each categories based upon a summation of said computed normative scores, and values of said normative scores extracted from received inputs;
d. computer readable program code translating said calculated category scores based upon a GMI curve;
e. computer readable program code computing an overall headline score based upon an asymmetric geometric scoring of weighted translated category scores;
f. computer readable program code computing an overall entity score based upon a summation of translated computed headline scores, said translation done via said GMI curve; and
g. computer readable program code utilizing said overall entity score to predict said corporate governance risk.

17. An article of manufacture comprising a computer usable medium implementing a scoring methodology that combines asymmetric and non-linear arithmetic scoring to predict corporate governance risk, as per claim 16, wherein said asymmetric geometric scoring is based upon:
a. computer readable program code dividing category scores into the following regions: scores in a first region representing category scores that are two or more standard deviations below the mean, scores in a second region representing category scores that are between two standard deviations below the mean and two standard deviations above the mean, and scores in a third region representing scores that are two or more standard deviations above the mean;
b. for a category score that fall in said first region, computer readable program code calculating the total contribution of that category towards said headline score as given by: normal arithmetic contribution −2*(NAC−maximum category score);
c. for a category score that fall in said second region, computer readable program code calculating the total contribution of that category towards said headline score as given by the product of the category score and the category weighting; and
d. for a category score that falls in said third region, computer readable program code calculating the contribution of that category score towards said headline score as 1.5 times the normal arithmetic contribution.
